(19) United States
(12) Patent Application Publication
(10) Pub. No.: US 2007/0207820 A1
(43) Pub. Date: Sep. 6, 2007

(54) Remotely accessible short messages

(76) Inventor: Michael Ke Zhao, Qingdao (CN)

Correspondence Address: CARLSON, GASKEY & OLDS, P.C., 400 W MAPLE RD, SUITE 350, BIRMINGHAM, MI, 48009, US

(21) Appl. No.: 11/367,112

(22) Filed: Mar. 3, 2006

(51) Int. Cl. H04Q 7/20

(52) U.S. Cl. 455/466

(57) ABSTRACT

Short messages such as SMS format messages intended for a mobile station (24) can be accessed using a second, different device (42-46) to increase the accessibility of such messages. A disclosed example includes a message center (22) that has a receiver portion (34) for receiving short messages from a plurality of device (26-32) on behalf of an intended recipient mobile station (24). A message storage portion (36) at least temporarily stores such messages at the message center (22). An access portion (40) provides access to such a short message responsive to a valid request from a second, different device (42-46) so that such a message can be received at the second, different device.

### FIELD OF THE INVENTION

This invention generally relates to communication. More particularly, this invention relates to accessing short messages in wireless communications.

### DESCRIPTION OF THE RELATED ART

Wireless communication systems are well known and in widespread use. Mobile stations such as cell phones provide an individual the ability to communicate over an air interface with a wireless communication network that allows for communicating with other mobile stations or line based telephones, for example. Most wireless communication systems facilitate voice communications and data communications.

One type of communication that has become popular in wireless communication systems includes sending short messages to mobile stations. A short message service (SMS) is available on many digital mobile stations. SMS permits sending short messages such as text messages between mobile stations and even line based telephones in some cases. Such messages are sent using a store-and-forward mechanism to a message service center that attempts to send the message to the intended mobile station. In some instances, the message service center will store received messages and retry sending them to an intended mobile station if it is not reachable at the time of the initial try. Mobile stations can be used to send and receive such messages. While such messaging has become popular and is very useful, there are drawbacks.

Message delivery is typically carried out on a best effort basis and there are no guarantees that a message will actually be delivered to the intended recipient. Delay or complete loss of the message is not uncommon, particularly when messages are sent between networks. Another significant drawback to known arrangements is that an individual can only retrieve short messages using the mobile station to which such messages are directed. This presents an inconvenience when an individual does not have access to their mobile station or they are in a location that does not include wireless communication “coverage” so that they do not have access to their messages.

It would be beneficial to expand the availability of short messages sent to or intended for mobile stations. This invention provides a technique for doing that.

### SUMMARY OF THE INVENTION

This invention expands the availability of short messages by providing access to a short message intended for a mobile station to an individual using a device other than the mobile station.

An exemplary method of communicating includes accessing a short message intended for a mobile station pursuant to a request for access to the short message from a second, different device.

One example includes receiving the short message at a message center, maintaining the short message at the message center and providing access to that short message to the second, different device responsive to a received request for access.

One example includes determining whether the request properly identifies the mobile station to which the short message was directed. A determination is also made whether the request includes a valid access authorization (e.g., a password) before providing access to the short message.

Another example includes sending the request for access from the second, different device and then receiving the short message at the second, different device.

With the example implementation of this invention, it is possible to use another mobile station, a computer or a personal digital assistant, for example, to retrieve messages intended for or directed to a mobile station without using that mobile station.

An example message center includes a receiver portion for receiving a short message that is intended for a mobile station. A storage portion stores the received short message on behalf of the intended mobile station. An access portion receives a request from a second device that is different from the intended mobile station regarding a desired access to the stored short message. The access portion provides the second device access to the stored short message responsive to the request.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of a communication system including an embodiment of this invention.

FIG. 2 is a flowchart diagram summarizing one example approach.

### DETAILED DESCRIPTION

This invention provides enhanced access to short messages for mobile stations by permitting access to those messages from a device other than the mobile station to which the message was directed.

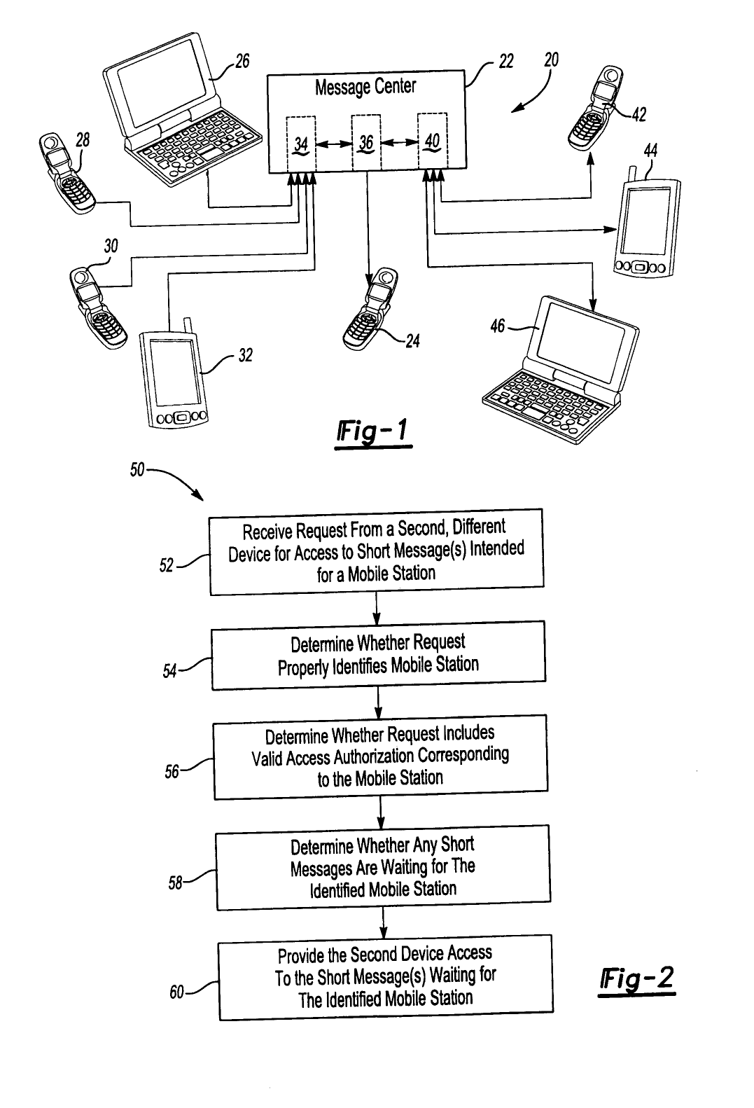

FIG. 1 schematically shows an example communication system 20. A message center 22 such as a short message service center processes short messages on behalf of a mobile station 24. A plurality of different devices such as a computer 26, phones 28 and 30, and a personal digital assistant 32 send messages intended for the mobile station 24. The devices 26-32 that send such messages may be mobile stations or may utilize traditional telephone line connections for sending short messages.

This description uses the term “short messages” to refer to those messages that are sent from a sending device to a message transfer agent such as a short message service center (SMS-C) and then sent to the intended recipient mobile station by the message transfer agent. Several standards are used for short messages including SMS -UCP, SMS-SMPP, SMTP and SNPP. Short messages that are handled using embodiments of this invention may be text messages, visual image messages (e.g., still picture image or video) or audio messages (e.g., music or recorded voice), for example. Short message service format messages having any one or a combination of these example contents may be accessed using the example of this description.

The illustrated message center 22 includes a receiver portion 34 for receiving short messages using known techniques and protocols, for example. The message center 22 may be a portion of a wireless communication network or have access to it for receiving short messages. A message storage portion 36 at least temporarily stores a received message and attempts to send it to the intended recipient mobile station 24. In one example, even though a message is sent to the mobile station 24, the message storage portion 36 retains the message for a selected period of time (e.g., one week).

With the illustrated example, a short message intended for the mobile station 24 may be retrieved using a second, different device. The example message center 22 includes an access portion 40 that facilitates allowing a variety of devices to access a short message intended for the mobile station 24. In this example, another mobile station such as a cell phone 42 or a personal digital assistant 44 communicates with the access portion 40 to gain access to any short message(s) intended for the mobile station 24. The example of FIG. 1 also includes a computer 46 that is capable of communicating with the access portion 40. The computer 46 may be a mobile station such as a notebook computer having wireless communication capabilities or may use a line based connection with an appropriate network or the internet to retrieve the message(s).

In one example, the access portion 40 will only provide access to short messages available from the message storage portion 36 that were intended for a mobile station 24 when the second, different device 42-46 provides an appropriate request for such messages. In one example, the request must at least identify the mobile station 24 and include an authorization code such as a password. Upon receipt of an appropriate request, the access portion 40 allows the second device 42-46 access to messages for the corresponding mobile station 24 provided that there is at least one such message available from the storage portion 36.

The various portions of the message center 22 are schematically divided for discussion purposes. Each of those portions may have some functionality integrated with another portion or be subdivided as may be needed in a particular situation. Those skilled in the art who have the benefit of this description will realize how to use software, hardware or a combination of them to achieve the functionality of the example portions in a manner that meets their particular needs.

FIG. 2 includes a flowchart diagram 50 summarizing one example approach for managing access to short messages at a message center 22. The process in FIG. 2 begins at 52 where the message center 22 receives a request from at least one of the second devices 44-46 requesting access to short messages intended for the mobile station 24, for example. At 54, the message center 22 determines whether the request properly identifies the mobile station 24. At 56, a determination is made whether the request includes a valid access authorization corresponding to the mobile station 24. For example, the owner of a mobile station can set an appropriate access code such as a password that must accompany a request for access to short messages intended for that mobile station. The access portion 40 in one example uses a look up table containing such information so that a comparison between a received request and a valid authorization code may be made to determine whether the request should be honored or denied.

At 58, a determination is made within the message center 22 whether any short messages are waiting or available for the identified mobile station 24. At 60, the access to any such short message is provided to the second device 42-46 and communicated to that device in a format such that the content of the message can be discernable at that device.

As can be appreciated from the disclosed example, greater accessibility to short messages intended for mobile stations becomes available with implementations of this invention. A mobile subscriber is no longer limited to using only a particular mobile station for accessing short messages sent to that mobile subscriber.

One advantage to using the disclosed example is that some short messages may include content that cannot be processed by the particular mobile station to which the message was directed. For example, a mobile station may be capable of displaying text messages but not visual image content from a short message. For such situations, the disclosed example implementation of this invention allows the mobile station owner to use another device that can display visual image content from a short message on a suitable device other than the mobile station to which the message was directed.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A method of communicating, comprising
accessing a short message intended for a mobile station pursuant to a request for access to the short message from a second, different device.

2. The method of claim 1, comprising
receiving the short message at a message center;
maintaining the short message at the message center; and
providing access to the maintained short message to the second, different device responsive to the request.

3. The method of claim 2, comprising
determining whether the request identifies the mobile station to which the short message was directed; and
determining whether the request includes a valid access authorization before providing the access to the short message to the second, different device.

4. The method of claim 1, comprising
sending the request from the second, different device; and
receiving the short message at the second, different device.

5. The method of claim 4, comprising
including an identifier of the mobile station with the request; and
including an access authorization with the request.

6. The method of claim 4, comprising
sending the request to a message center that maintains the short message on behalf of the mobile station.

7. The method of claim 1, wherein the second, different device comprises one of another mobile station, a computer or a personal digital assistant.

8. The method of claim 1, wherein the short message comprises at least one of a text message, visual image content or audio content.

9. A message center, comprising
a receiver portion for receiving a short message that is intended for a mobile station;
a storage portion for storing the received short message on behalf of the intended mobile station; and
an access portion for receiving a request from a second device that is different from the intended mobile station regarding a desired access to the stored short message and providing the second device access to the stored short message responsive to the request.

10. The message center of claim 9, wherein the access portion determines if the request is valid before providing the second device access to the stored short message.

11. The message center of claim 10, wherein the access portion determines whether the request properly identifies the intended mobile station and includes a valid access authorization.

12. The message center of claim 9, wherein the access portion provides access to the stored short message responsive to a request from the intended mobile station.

13. The message center of claim 9, wherein the second device comprises one of another mobile station, a computer or a personal digital assistant.

14. The message center of claim 9, wherein the short message comprises at least one of a text message, visual image content or audio content.
